(19) United States
(12) Patent Application Publication
(10) Pub. No.: US 2007/0048526 A1
(43) Pub. Date: Mar. 1, 2007

(54) Recycling compatible hard coating

(76) Inventors: William F. Hoffman III, Palatine, IL (US); Steven M. Scheifers, Hoffman Estates, IL (US); Doreen Schnecke, Wiesbaden (DE)

Correspondence Address: MOTOROLA, INC., 1303 EAST ALGONQUIN ROAD, IL01/3RD, SCHAUMBURG, IL, 60196, US

(21) Appl. No.: 11/215,917

(22) Filed: Aug. 31, 2005

(51) Int. Cl. B32B 27/36

(52) U.S. Cl. 428/412

(57) ABSTRACT

A recyclable plastic article having a scratch resistant coating. An injection molded thermoplastic article is coated with a polymeric or inorganic coating so as to enable the coating to be compatible with the thermoplastic during the recycling process. The polymeric hard coat contains functional chemical groups that interact with the underlying thermoplastic resin to render the coating miscible with the thermoplastic resin when the recyclable plastic article is ground, pelletized and molded. After the typical recycling process of grinding, pelletizing, and molding, the thermoplastic resin retains at least 95% of the original mechanical properties of the virgin resin. Compatibilization agents and other processing steps are not needed to insure proper recycling.

### FIELD OF THE INVENTION

This invention relates generally to coated thermoplastics. More particularly, this invention relates to coatings that are compatible with plastic recycling programs.

### BACKGROUND

Recycling of plastics continues to grow in popularity owing to ecological concerns and the like. Much progress has been made in the field of plastic recycling, to the extent that consumers now incorporate it into their daily life. Huge quantities of plastics such as polyethylene (PE) and polyethylene terephthalate (PET) are recycled worldwide, and other opportunities for recycling plastic remain large. One market segment that has a large potential for recycling is electronic devices, particularly handheld devices such as cellular telephones. Unfortunately, there are significant technological problems with recycling electronic devices as compared to bottles. In a typical recycling operation, collected plastic is classified according to the type of resin. Thereafter, the various colors are sorted and then crushed for coarse powdering and grinding, then pelletized to obtain a resin that is ready to be injection molded. Unlike bottles, electronic devices typically have numerous modifications to the exterior of the plastic housing, such as scratch resistant coatings or hard coatings (to enhance the cosmetic appearance of the device and extend longevity), paint, labels, etc. These exterior treatments must be removed before the plastic resin can be re-molded into another artifact. If not, the various treatments will contaminate the plastic and cause defects in the molded article or degrade the physical properties of the recycled plastic. Many scenarios for reuse of coated thermoplastic resin moldings have been made and proposed in the patent literature. The methods set out in the prior art can be broadly classified into: removing a paint film by a physical manner, separation with solvents, hydrolyzing a paint film, adding a compatibilization agent, and a method wherein a molding is crushed and used as it is. While these various methods of removing paints and labels have been developed in the industry, removal of scratch resistant coatings remains an unsolved problem. This is because the materials typically used in scratch resistant coatings are of a different type than that used to form the molded plastic article. More particularly, the resins used for moldings are composed of thermoplastic resins, whereas hard coatings are mainly made of thermosetting resins such as urethane resins, epoxy resins and the like. As these coatings are intended by the design engineer to be durable and adhere tightly to the underlying plastic, they are nearly impossible to remove without destroying the underlying plastic. When the hard coated thermoplastic resin is subjected to the recycling process, the two different types of resins do not have an affinity for each other, and separate, causing the recycled plastic to have degraded properties.

Thus, the issue of how to recycle hard coated thermoplastic resins remains unsolved, and it would be a significant improvement in the industry if this problem could be solved.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. Where cited, specific materials are intended to serve as teachings of some suitable materials for the task at hand, and the citations are not intended to be limiting or indicative that these are the only materials that are suitable. An injection molded thermoplastic article is coated with a polymeric or inorganic coating so as to enable the coating to be compatible with the thermoplastic during the recycling process. The polymeric hard coat contains functional chemical groups that interact with the underlying thermoplastic resin to render the coating miscible with the thermoplastic resin when the recyclable plastic article is ground, pelletized and molded. After the typical recycling process of grinding, pelletizing, and molding, the thermoplastic resin retains at least 95% of the original mechanical properties of the virgin resin.

Compatibilization agents and other processing steps are not needed to insure proper recycling.

Housings made for handheld electronic devices such as cellular telephones, two way radios, personal digital assistants (PDA), laptop computers, remote controls, conventional telephones, etc. typically are injection molded from thermoplastic resins such as acrylonitrile-butadiene-styrene (ABS), polycarbonate (PC), polyethylene (PE), polypropylene, polymethyl-methacrylate, polyethylene terephthalate (PET), polystyrene (PS), styrene-modified acrylic, chlorinated polypropylene, polyamide, and blends thereof. These resins are selected for their appearance, ease of molding, and ability to be decorated. Since handheld devices are subjected to extensive ‘wear and tear’ from continual handling, the thermoplastic resin, being somewhat soft, tends to easily scratch, and the ‘like-new’ cosmetic appearance of the product quickly diminishes. One way to address this problem is to lightly texture the exterior of the housing so that scratches are less noticeable. However, over time, even the textured surface becomes degraded and wears away, dramatically changing the appearance of the device. Clear plastic lenses used to cover liquid crystal displays are particularly prone to scratching, because even minute scratches are highly visible, and lenses certainly cannot be textured. Another solution to this problem is to deposit a ‘hard coating’ or ‘scratch resistant coating’ on the affected surface of the thermoplastic housing. These coatings typically are transparent thermosetting polyurethane resins. Polyurethane (PU) can be formulated to be highly scratch resistant, transparent, chemically resistant, durable, non-yellowing, and highly adherent to various thermoplastics, so that it will not scratch, chip, fade, or peel off the plastic. This substantially enhances the cosmetic appearance of the handheld device by retaining the attractive factory finish of the underlying molded thermoplastic resin.

However, the extreme stability of cross linked PU becomes a penalty when the housing is to be recycled. The hard coatings must be removed before the molded housing can be recycled and molded into another artifact, because PU is a thermosetting resin (does not remelt) whereas the housing is a thermoplastic resin. When the thermoplastic resin is remelted in the recycling process, the PU is immiscible in the thermoplastic resin and creates ‘phase boundaries’ and separates. If not removed, the PU hard coat contaminates the thermoplastic resin and causes defects in the second generation molded article or degrades the physical properties of the recycled plastic. In order to improve the properties of the recycled plastic, a pretreatment that removes the coating is required, but the durability, chemical resistance, and strong adhesion makes it nearly impossible to remove the hard coating without damaging or degrading the underlying thermoplastic resin.

One approach to this problem has been to add reactive compatibilization agents to the resin in the pelletization process, or during the extrusion and/or molding process to improve the blending between the immiscible portions of the polymer blend. There are several patents that relate to the post recovery compatibilization of multiple immiscible polymeric materials, such as U.S. Pat. No. 6,469,099B1. However, this approach has had marginal success, and post recovery compatibilization represents a costly extra step in recycling process.

Our disclosed invention alters the scratch resistant hard coat film prior to or during the initial manufacture of the housing. The coating provides the needed protection during use and is compatible with recycling to allow recycling of housings without any further processing and minimizes degradation of the recycled polymer properties. The coating does not need to be removed during recycling, thus reducing cost and cycle time for end of life processing of products.

The concept of ‘scratch resistance’ is one that is obviously subject to a high degree of variability in interpretation. Certainly, the scratch resistance needed for hard steel tooling is substantially different from scratch resistance needed for flexible vinyl resins. For purposes of handheld consumer electronic devices with thermoplastic housings, a number of testing methods are currently used, for example resistance to shallow scratching is often defined by the Steel Wool Scratch Test, and resistance to deep scratching is often defined by the Pencil Hardness Test, both performed on the Norman Abrasion Wear Tester, model number 7-IBB-64, manufactured by Norman Tool Inc, Evansville, Indiana. The proper combination of performance in these tests provides protection from both deep and shallow scratches and provides adequate protection for general field usage. The Pencil Hardness Test is conducted in accordance with ASTM D 3363-74. The hardness of the tested surface is defined as the hardness of the last pencil, proceeding from softest to hardest, that does not scratch or mar the surface in any way. The Steel Wool Scratch Test is performed by placing a piece of #0000 steel wool on the surface of the hard coated plastic under a one (1) pound weight and moving the steel wool back and forth across the surface for a number of cycles. Failure is defined as the number of cycles need to create the appearance of any significant number of fine scratches when viewed in a lighted environment from a distance of eighteen (18) inches.

The existence of a few tiny scratches is acceptable, but a ‘haze’ of scratches is not. These repeatable tests can then be used to provide a quantitative scratch resistance rating.

Obviously, each product and manufacturer will have their own unique requirements for scratch resistance, but an average requirement would be resistance in the Pencil Hardness Test of HB and no scratches after 20 cycles in the Steel Wool Scratch Test.

In one embodiment of our invention, a recyclable plastic article having a scratch resistant coating is made by applying a polyurethane coating to an injection molded thermoplastic article, such as a housing for an electronic device. Although thermoplastics such as acrylonitrile-butadiene-styrene, polycarbonate, polyethylene, polypropylene, polymethyl-methacrylate, polyethylene terephthalate, polystyrene, styrene-modified acrylic, chlorinated polypropylene, polyamide and blends thereof can be used, the most common plastic today for consumer electronic devices is polycarbonate and polycarbonate blends. The polyurethane hard coat contains functional chemical groups that interact with the underlying thermoplastic resin to render the polyurethane coating miscible with the thermoplastic resin when the recyclable plastic article is ground, pelletized and molded. The following examples are presented to illustrate some reactions than can be employed to accomplish this, and are not intended to be limiting.

### EXAMPLE 1

A polyurethane hard coat is formed by reacting a diol such as bisphenol A (BPA) with a diisocyanate such as methylene-4,4′-diphenyldisocyanate (MDI) as depicted in the following reaction:

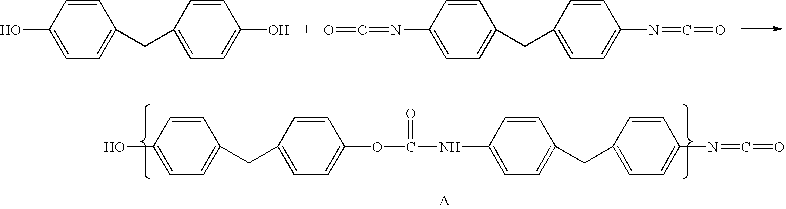

This typical PU hard coat (A) can be combined with another polymer to form a block copolymer. The reactant polymer (B) is formed by reacting a diamine such as ethylene diamine with a diisocyanate such as methylene-4,4′-diphenyldisocyanate (MDI):

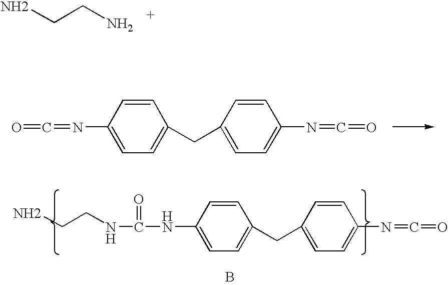

The two polymers (A and B) are then further reacted to form a block copolymer:

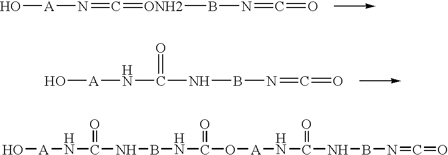

This thermoset copolymer now has the properties of a hard coat along with a great affinity for the polycarbonate thermoplastic.

### EXAMPLE 2

Another version of an AB block copolymer is formed by reacting a polycarbonate trimer with MDI instead of bisphenol A used in Example 1. Note that the trimer diisocyanate can be used as the linker diisocyanate in the final coating formulation as well as being a part of the backbone of the main polymer.

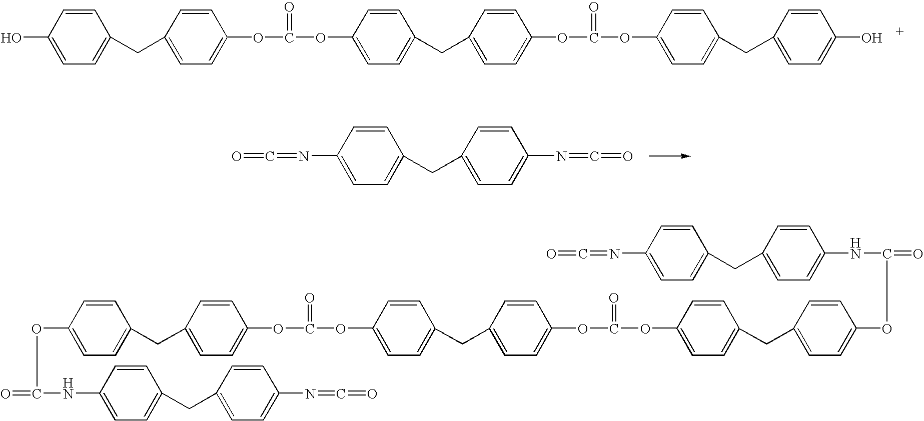

Modifications to block copolymers are numerous, for example, adding block copolymers of the type of plastic resin employed as the molded thermoplastic housing. For polycarbonate this would be bisphenol A or PC oligimers thereof. This can also be substituted for the butanediol.

Additionally, pendant groups can be grafted to the active hydrogen urea linkage of a prepolymer or the carbamate. Again, for PC this can be done by attaching a linker molecule to the hydroxyl group of bisphenol A that contains a halogen having the form RX where R is the organic and X is the halogen. RX attacks the active hydrogen with HX being eliminated to yield:

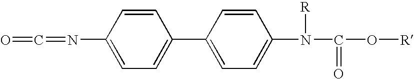

This is all done prior to the final formulation with extra diisocyanate for the curing step when “coated” onto a substrate.

### EXAMPLE 3

Another type of reaction forms an amide polymer having pendant amine and isocyanate groups that are available for either further reaction with functional groups (such as isocyanates) on the thermoplastic resin or with, for example, a PC trimer. The reactive pendant groups also allow the coating to be compatible with the thermoplastic resin in the melt stage.

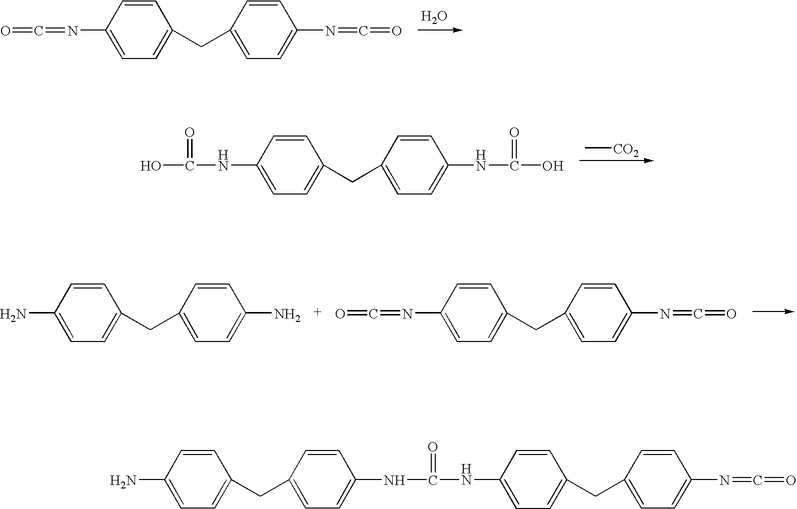

### EXAMPLE 4

A number of reactions are available to create polycarbonate dendrites that will increase the compatibility of the hard coating with the melted thermoplastic. The reaction with the diisocyanate forms a urethane. Additionally, a polyol or diamine can be reacted with polymers or prepolymers that already have isocyanate groups present. In Examples 4-15, R is a polycarbonate dimer, trimer or other oligomeric form. The wavy chain ( [symbol] ) depicted in the examples below represents one or more methylene, aromatic rings, or other organic groups constituting an organic chain. Reaction products shown below are not necessarily preferred and are not necessarily the only products. In some cases, as in example 4, the acid chloride may react with the primary amine as well, leaving the secondary amine, primary amine, and the amido nitrogens available to react with isocyanate terminal groups to form the hardcoat backbone. Further, it will be appreciated by one skilled in the art that the reagents are exemplary only. Thus, the acid chloride in example 4 could be substituted with a carboxylic acid or anhydride, or it could be an acid bromide.

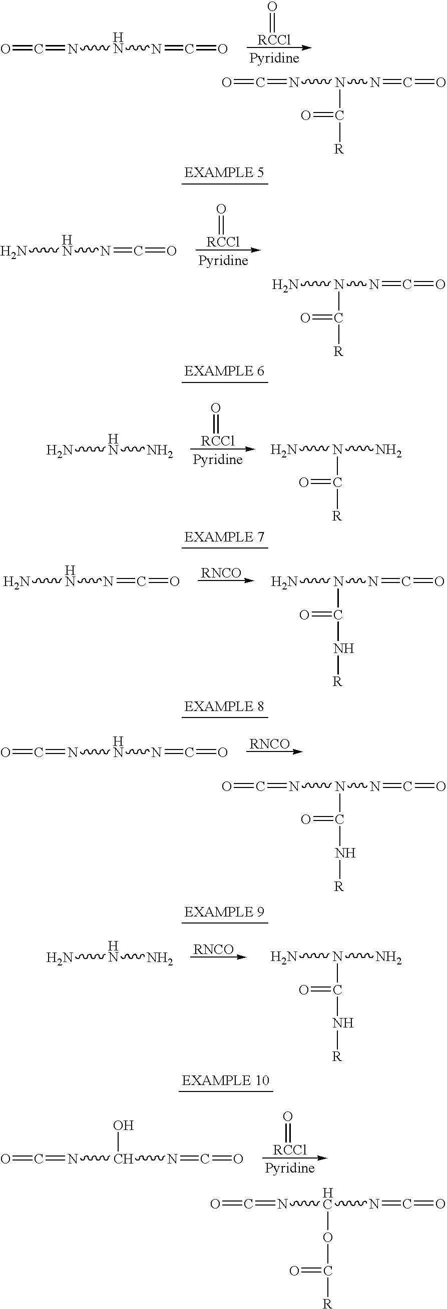

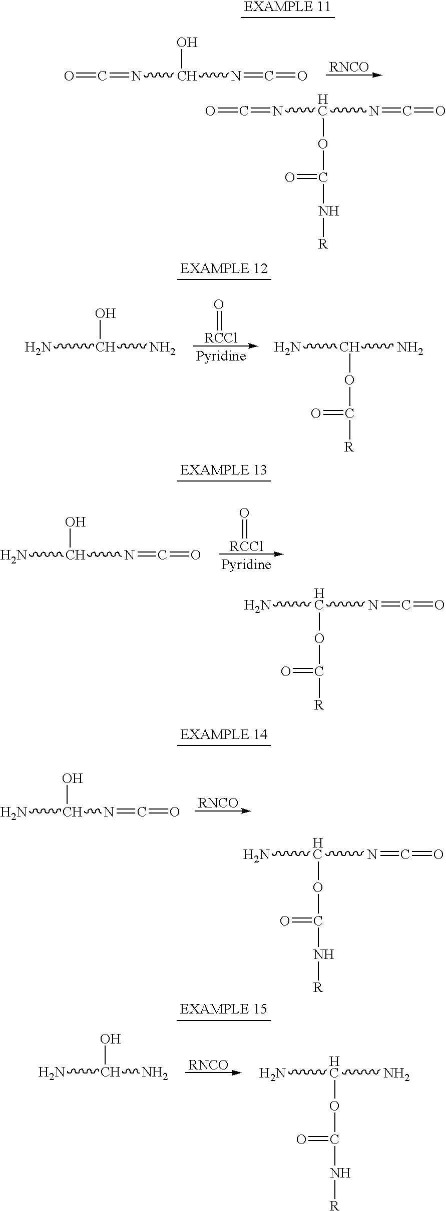

These pendant functional groups interact with the polycarbonate to allow the hard coated housing to be reground and remolded without experiencing the problem of phase separation. Thus, the costly step of addition of compatibilization agents taught in the prior art during the recycling process is eliminated.

In another embodiment of our invention, a recyclable plastic article having a scratch resistant coating is made by applying an epoxy coating to an injection molded thermoplastic article, such as a housing for an electronic device. Modification to the epoxy prepolymers and polymers is performed in a similar manner as with the polyurethane described above, but with the chemistry changed appropriately.

In still another embodiment of our invention, a recyclable plastic article having a scratch resistant coating is made by applying an inorganic hard coating, for example, corundum or glass (silica), to an injection molded thermoplastic article, such as a housing for an electronic device. Examples of suitable corundum coatings are alumina, sapphire, ruby, and garnet. The silica or corundum can be silanated using active hydroxyl groups on the surface of the molecules. The silane linkers follow the typical silanization chemistry where methoxy or ethoxy or the silicon version of the acid halide such as Cl_{y}-Si-R_{(4-y)} where Y is the number of Cl moieties and is a number from 1 to 3. The R. group is again a PC oligomer or Bisphenol A for PC based thermoplastics. One skilled in the art will recognize the many possibilities that can be used to attach compatibilization groups to these inorganic hard coat additives to achieve miscibility. The inorganic coatings can be applied in a number of ways, such as evaporation, chemical vapor deposition, flame spraying, plasma deposition, etc. to form a thin film on the plastic housing surface.

In a further embodiment of our invention, a recyclable plastic article having a scratch resistant coating is made by mixing an inorganic material, for example, corundum or glass (silica), in an epoxy or urethane resin matrix, and then applying the mixture to an injection molded thermoplastic article, such as a housing for an electronic device. Examples of suitable corundum coatings are alumina, sapphire, ruby, and garnet. During the recycling process, the inorganic material becomes uniformly incorporated within the thermoplastic polymer matrix and acts as a filler, without degrading the physical properties.

In a further embodiment of our invention, the recyclable plastic article as described herein may find particular use in portable communications applications. Portable radios may operate in either receive or transmit modes, and typically include a receiver and, optionally, a transmitter. In the receive mode, the portable radio receives a communication signal via an antenna. A transmit/receive switch couples the received communication signal to the receiver. The receiver receives and demodulates the received communications signal. In the transmit mode, audio or data is transmitted as is wellknown in the art. It may be appreciated by one of ordinary skill in the art that other functions not herein described may be provided by any suitable means, including a controller means, which controls the entire operation of the radio.

Our invention of modifying the scratch resistant hard coating prior to deposition onto the thermoplastic housing to make it compatible with the thermoplastic resin during the typical recycling process of grinding, pelletizing, and molding allows second generation moldings to be made while retaining at least 95% of the original mechanical properties of the virgin resin. Compatibilization agents and other post-processing steps are not needed to insure proper recycling For example, physical properties such as melt flow rate, flexural modulus, yield strength, notched Izod impact strength and tensile strength each retain at least 95% of their original values. For example, an electronic device housing molded from a typical commercial grade polycarbonate resin coated with a polyurethane hard coat in accordance with our invention has the following properties before and after recycling:

| PROPERTY | VIRGIN | RECYCLED |
|---|---|---|
| Melt Flow Rate | 8-12 | 7.6-11.4 |
| Flexural Modulus | 324,000 | 308,000 |
| Notched Izod Impact | 15 | 14.3 |
| Yield Strength | 8.0 | 7.6 |
| Tensile Strength (break) | 7300 psi | 6935 psi |

In summary, without intending to limit the scope of the invention, an injection molded thermoplastic article can be hard coated with a polymeric or inorganic coating so as to enable the coating to be compatible with the thermoplastic during the recycling process, according to a method consistent with certain embodiments of the above described invention. Those skilled in the art will recognize that the present invention has been described in terms of exemplary embodiments based upon use of a polyurethane or epoxy resin on a molded polycarbonate housing. However, the invention should not be so limited, since other variations will occur to those skilled in the art upon consideration of the teachings herein. While the invention has been described in conjunction with specific embodiments, it is evident that many alternatives, modifications, permutations and variations will become apparent to those of ordinary skill in the art in light of the foregoing description. For example, the entire housing does not need to be covered with the scratch resistant hard coat, but selected portions may only be covered, as desired. Additionally, a housing could be fabricated from nylon (a polyamide) instead of polycarbonate and a hard coat applied over that. Accordingly, it is intended that the present invention embrace all such alternatives, modifications and variations as fall within the scope of the appended claims.

What is claimed is:

1. A recyclable plastic article having a scratch resistant coating, comprising:
a recyclable plastic article comprising a thermoplastic resin; and
a polyurethane having functional chemical groups, and coated on at least a portion of the recyclable plastic article so as to substantially increase the scratch resistance of the recyclable plastic article, the chemically functional groups enabling the polyurethane to be miscible with the thermoplastic resin when the recyclable plastic article is ground, pelletized and molded.

2. The recyclable plastic article as described in claim 1, wherein one or more physical properties selected from the group consisting of melt flow rate, flexural modulus, yield strength, notched Izod impact strength and tensile strength retains at least 95% of the original value after the recyclable plastic article is recycled by grinding, pelletizing, and molding without the addition of compatibilization agents.

3. The recyclable plastic article as described in claim 1, wherein the thermoplastic resin is polycarbonate or a polycarbonate blend.

4. The recyclable plastic article as described in claim 1, wherein the polyurethane comprises a block copolymer of polyurethane and polycarbonate.

5. The recyclable plastic article as described in claim 1, wherein the functional chemical groups comprise moieties that interact with the thermoplastic resin.

6. A recyclable plastic article having a scratch resistant coating, comprising:
a recyclable plastic article comprising a thermoplastic resin; and
an inorganic coating on at least a portion of the recyclable plastic article so as to substantially increase the scratch resistance of the recyclable plastic article, the inorganic coating being miscible with the thermoplastic resin when the recyclable plastic article is ground, pelletized and molded.

7. The recyclable plastic article as described in claim 6, wherein one or more physical properties selected from the group consisting of melt flow rate, flexural modulus, yield strength, notched Izod impact strength and tensile strength retains at least 95% of the original value after the recyclable plastic article is recycled by grinding, pelletizing, and molding without the addition of compatibilization agents.

8. The recyclable plastic article as described in claim 6, wherein the thermoplastic resin is polycarbonate or a polycarbonate blend.

9. The recyclable plastic article as described in claim 6, wherein the inorganic coating comprises corundum or glass.

10. The recyclable plastic article as described in claim 9, wherein the inorganic coating comprises one or more materials selected from the group consisting of alumina, sapphire, ruby, and garnet.

11. The recyclable plastic article as described in claim 6, wherein the inorganic coating is silanized prior to being applied to the recyclable plastic article.

12. The recyclable plastic article as described in claim 6, wherein the inorganic coating comprises particles of glass or corundum suspended in a matrix of polyurethane resin or epoxy resin.

13. The recyclable plastic article as described in claim 12, wherein the particles are nanoparticles.

14. The recyclable plastic article as described in claim 12, wherein the polyurethane resin contains chemically functional groups enabling the polyurethane resin to be miscible with the thermoplastic resin when the recyclable plastic article is ground, pelletized and molded.

15. A recyclable plastic radio housing having a scratch resistant coating, comprising:
a plastic radio housing comprising one or more polymers selected from the group consisting of acrylonitrile-butadiene-styrene, polycarbonate, polyethylene, polypropylene, polymethyl-methacrylate, polyethylene terephthalate, polystyrene, styrene-modified acrylic, chlorinated polypropylene, polyamide, and blends thereof; and
a scratch resistant coating on at least a portion of the plastic radio housing so as to substantially increase the scratch resistance of the plastic radio housing, the coating being miscible with the thermoplastic resin sufficient that one or more physical properties selected from the group consisting of melt flow rate, flexural modulus, yield strength, notched Izod impact strength and tensile strength retains at least 95% of the original value after the recyclable plastic radio housing is recycled by grinding, pelletizing, and molding without the addition of compatibilization agents.

16. The recyclable plastic radio housing as described in claim 15, wherein the scratch resistant coating comprises one or more materials selected from the group consisting of polyurethane, epoxy, glass, alumina, sapphire, ruby, and garnet.

17. The recyclable plastic radio housing as described in claim 15, wherein the polyurethane contains chemically functional groups enabling the polyurethane to be miscible with the thermoplastic resin when the recyclable plastic radio housing is ground, pelletized and molded.

18. The recyclable plastic radio housing as described in claim 15, wherein the epoxy contains chemically functional groups enabling the epoxy to be miscible with the thermoplastic resin when the recyclable plastic radio housing is ground, pelletized and molded.

19. The recyclable plastic radio housing as described in claim 15, wherein the scratch resistant coating is silanized prior to being applied to the plastic radio housing.
